(19) United States
(12) Patent Application Publication
(10) Pub. No.: US 2008/0186351 A1
(43) Pub. Date: Aug. 7, 2008

(54) FLUID EJECTING APPARATUS AND METHOD OF CONTROLLING SAME

(75) Inventor: Nobuhito TAKAHASHI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/027,807

(22) Filed: Feb. 7, 2008

(30) Foreign Application Priority Data
Feb. 7, 2007 (JP) 2007-028191

(51) Int. Cl. B41J 29/393; G01N 11/06; B05B 12/10

(52) U.S. Cl. 347/19; 73/54.13; 73/54.02; 239/75

(57) ABSTRACT

A fluid ejecting apparatus includes an ejection head having an ejection face formed with an ejection nozzle that ejects fluid, a detection device having a detector that is arranged to face the ejection face with a predetermined gap provided therebetween and to which the fluid ejected from the ejection nozzle is supplied, the detection device outputting a detection signal in response to the fluid ejected from the ejection nozzle, a processing unit that obtains information on the viscosity of the fluid on the basis of the detection signal, a measurement device that measures an elapsed time from a reference time and outputting the measured value, a maintenance device capable of performing maintenance of the ejection head, and a control device that controls the maintenance device on the basis of the measured value output from the measurement device. The measurement device changes the measured value to be output on the basis of the information obtained by the processing unit.

The entire disclosure of Japanese Patent Application No. 2007-028191, filed Feb. 7, 2007, is expressly incorporated by reference herein.

### BACKGROUND OF THE INVENTION

1. Field of the Invention

The present invention relates to a fluid ejecting apparatus and a method of controlling a fluid ejecting apparatus.

2. Description of the Related Art

As fluid ejecting apparatuses, ink jet-type recording apparatuses that eject ink onto a recording medium from an ejection nozzle of a record head have been known. When a period of time during which ink is not ejected from the ejection nozzle becomes long, the viscosity of ink inside the record head increases, and accordingly, there is a possibility that a situation in which the ink cannot be smoothly ejected occurs. Accordingly, an operation for regularly discharging ink from the ejection nozzle such as a flushing operation, a suction operation, or the like is performed (see JP-A-2006-123499).

However, when the operation for discharging ink is performed in a case where the viscosity of ink has not increased, the ink is consumed unnecessarily. A method in which a change in the viscosity of the ink is predicted and the operation for discharging the ink is performed based on the result of prediction may be considered to be used. However, since the environment (temperature, humidity, and the like) under which the ink jet-type recording apparatus is used is not constant, it is difficult to predict the change in the viscosity of the ink.

### SUMMARY

The present invention is contrived in consideration of the above-described situation. The object of the invention is to provide a fluid ejecting apparatus and a method of controlling a fluid ejecting apparatus capable of suppressing unnecessary consumption of fluid such as ink and maintaining an excellent ejection state.

In order to achieve the above-described object, the present invention employs the following configurations.

According to a first aspect of the present invention, there is provided a fluid ejecting apparatus including: an ejection head having an ejection face formed with an ejection nozzle that ejects fluid; a detection device having a detector that is arranged to face the ejection face with a predetermined gap provided therebetween and to which the fluid ejected from the ejection nozzle is supplied, the detection device outputting a detection signal in response to the fluid ejected from the ejection nozzle; a processing unit that obtains information on the viscosity of the fluid on the basis of the detection signal; a measurement device that measures an elapsed time from a reference time and outputting the measured value; a maintenance device capable of performing maintenance of the ejection head; and a control device that controls the maintenance device on the basis of the measured value output from the measurement device. The measurement device changes the measured value to be output on the basis of the information obtained by the processing unit.

According to the first aspect of the invention, the detection device outputs the detection signal in response to the fluid ejected from the ejection nozzle. Accordingly, information on the viscosity of the fluid actually ejected from the ejection nozzle can be acquired. In a case where a maintenance process is performed based on a measured value of the measurement device that measures the elapsed time from the reference time by the maintenance device, by changing the measured value based on the information of the viscosity of fluid acquired by the processing device, an appropriate maintenance process by using the maintenance device can be performed. Accordingly, it is possible to suppress unnecessary consumption of fluid and maintain an excellent ejection state.

In the above-described configuration, the reference time may include a completion time of a maintenance process performed earlier. In such a case, an excellent ejection state can be maintained.

In the above-described configuration, the control device may control the maintenance device on the basis of the changed measured value. In such a case, an appropriate maintenance process can be performed.

In the above-described configuration, the content of the maintenance process performed by the maintenance device may be set in such a manner as to correspond to the elapsed time from the reference time, and the control device may set the content of the maintenance process on the basis of the measured value, and control the maintenance device on the basis of the set content. In such a case, an appropriate maintenance process can be performed.

In the above-described configuration, the maintenance device may be able to perform a maintenance process including an operation for discharging the fluid from the ejection nozzle in cooperation with the ejection head in order to maintain the ejection characteristics of the ejection head, and be able to perform the maintenance process in a plurality of modes in which the amounts of discharge of the fluid from the ejection nozzle differ from one another, and, on the basis of the measured value, the control device may select a specific mode from the plurality of modes and control the maintenance device so as to perform the maintenance process in the selected mode. In such a case, it is possible to perform an appropriate maintenance process while suppressing unnecessary consumption of the fluid, and thereby an excellent ejection state can be maintained.

In the above-described configuration, the maintenance process may include a process for performing a flushing operation for ejecting the fluid from the ejection nozzle in advance before the fluid from the ejection nozzle is supplied to a predetermined object. In such a case, an excellent discharge state can be maintained.

In the above-described configuration, the maintenance device may include a capping device having a cap member capable of forming a space with the ejection face, and a suction device capable of sucking fluid in the space. In such a case, the ejection head can be excellently maintained by using the capping device.

In the above-described configuration, the maintenance device may include the detector. In such a case, since a member is commonly used as the maintenance device and the detection device, process efficiencies of the maintenance process and the detection process can be improved, and thereby it is possible to save a space inside the apparatus.

In the above-described configuration, the detection device may supply an electric field between the ejection face and the detector and output a change in a voltage value with respect to time based on electrostatic induction when the fluid is moved from the ejection nozzle to the detector. In such a case, the information on the viscosity of the fluid can be acquired well.

In the above-described configuration, it may be configured that the detection signal contains the voltage value for each of a first time, a second time after a first period of time has passed from the first time, and a third time after a second period of time has passed from the second time, the voltage value is a reference value from the first time to the second time, the voltage value starts to change at the second time, and the voltage value reaches an extreme value at the third time, and the processing unit may determine at least one of the first period of time, the second period of time, and the difference between the reference value and the extreme value, and obtain information on the viscosity of the fluid on the basis of the determined result. In such a case, since at least one of the first time, the second time, and a difference between the reference value and the extreme value changes in response to the viscosity of the fluid, information on the viscosity of the fluid can be acquired well based on the change.

In the above-described configuration, a driving element that varies the pressure in the space connected to the ejection nozzle on the basis of a driving signal to be input in order to eject the fluid from the ejection nozzle may be further included, and the first time may include a time at which the driving signal is input to the driving element. In addition, in the above-described configuration, the second time may include a time at which the ejection of the fluid is started from the ejection nozzle, and the third time may include a time at which the fluid from the ejection nozzle reaches the detector. In such a case, the information on the viscosity of the fluid can be acquired well.

In the above-described configuration, a storage device storing a reference signal that is output from the detection device on the basis of fluid in an initial state may be further included, and the processing unit may obtain information on the amount of change in the viscosity of the fluid in the initial state on the basis of the detection signal and the reference signal. In such a case, the amount of a change in the viscosity of the fluid from the initial state can be acquired well.

In the above-described configuration, it may be configured that the detection signal contains the voltage value for each of a first time, a third time after a second period of time has passed from the first time, a second time after a first period of time has passed from the second time, the voltage value is a reference value from the first time to the second time, the voltage value starts to change at the second time, and the voltage value reaches an extreme value at the third time, the reference signal contains the voltage value for each of a first time, a fourth time after a third period of time has passed from the first time, and a fifth time after a fourth period of time has passed from the fourth time, the voltage value is a reference value from the first time to the fourth time, the voltage value starts to change at the fourth time, and the voltage value reaches an extreme value at the fifth time, and the processing unit determines at least one of information on the difference between the first period of time and the third period of time, information on the difference between the second period of time and the fourth period of time, and the difference between the extreme value of the detection signal and the extreme value of the reference signal, and obtains information on the viscosity of the fluid on the basis of the determined result. In such a case, since at least one of a difference between the first time and the third time, a difference between the second time and the fourth time, and a difference between the extreme value of the detection signal and the extreme value of the reference signal changes in response to the viscosity of the fluid for the initial state, the information on the viscosity of the fluid can be acquired well based on the change.

In the above-described configuration, a driving element that varies the pressure in the space connected to the ejection nozzle on the basis of a driving signal to be input in order to eject the fluid from the ejection nozzle may be further included, and the first time may include a time at which a diving signal is input to the driving element. In addition, in the above-described configuration, the second time and the fourth time may include a time at which the ejection of the fluid is started from the ejection nozzle, and the third time and the fifth time may include a time at which the fluid from the ejection nozzle reaches the detector. In such a case, the information on the viscosity of the fluid can be acquired well.

In the above-described configuration, the fluid may be liquid. In such a case, the detection device can output the detection signal well on the basis of the liquid ejected from the ejection nozzle.

According to a second aspect of the present invention, there is provided a method of controlling a fluid ejecting apparatus including an ejection head having an ejection face formed with an ejection nozzle that ejects fluid. The method includes: arranging a detector so as to face the ejection face with a predetermined gap provided therebetween, supplying the fluid ejected from the ejection nozzle to the detector, and obtaining a detection signal in response to the fluid ejected from the ejection nozzle by using the detector; obtaining information on the viscosity of the fluid on the basis of the detection signal; measuring an elapsed time from a reference time and outputting the measured value; and performing maintenance of the ejection head on the basis of the output measured value. The output measured value is changed on the basis of the information on the viscosity.

According to the second aspect of the invention, the detection signal in response to the fluid ejected from the ejection nozzle is acquired. Accordingly, information on the viscosity of the fluid actually ejected from the ejection nozzle can be acquired. In a case where a maintenance process is performed based on a measured value that measures the elapsed time from the reference time, by changing the measured value based on the acquired information of the viscosity of fluid, an appropriate maintenance process can be performed. Accordingly, it is possible to suppress unnecessary consumption of the fluid and maintain an excellent ejection state.

### BRIEF DESCRIPTION OF THE DRAWINGS

FIG. 1 is a perspective view of an ink jet printer according to a first embodiment.

FIG. 2 is a plan view of an ink jet printer according to the first embodiment.

FIG. 3 is a cross-sectional view showing a record head according to the first embodiment.

FIG. 4 is a perspective view showing a maintenance device according to the first embodiment.

FIG. 5 is a perspective view of a part of a maintenance device according to the first embodiment, viewed from the lower side.

FIG. 6 is a diagram showing an example of a suction device according to the first embodiment.

FIG. 7 is a diagram for describing a detection system according to the first embodiment.

FIG. 8 is a schematic diagram for describing the principle of a detection operation of a detection device.

FIG. 9 is a diagram showing an example of a detection signal output from a detection device according to the first embodiment.

FIG. 10 is a block diagram showing the electrical configuration of an ink jet printer.

FIG. 11 is a diagram showing an example of the content of maintenance associated with an elapsed time from a reference time.

FIG. 12 is a diagram showing an example of a driving signal input to a piezoelectric element.

FIG. 13 is a flowchart for describing an example of the operation of an ink jet printer according to the first embodiment.

FIG. 14 is a diagram showing a relationship between a detection signal and a reference signal according to the first embodiment.

FIG. 15 is a diagram showing an example of a condition for changing a measured value which is set in correspondence with information on viscosity of ink.

FIG. 16 is a flowchart for describing an example of an ink jet printer according to a second embodiment.

### DESCRIPTION OF THE PREFERRED EMBODIMENTS

Hereinafter, embodiments of the present invention will be described with reference to the accompanying drawings.

### First Embodiment

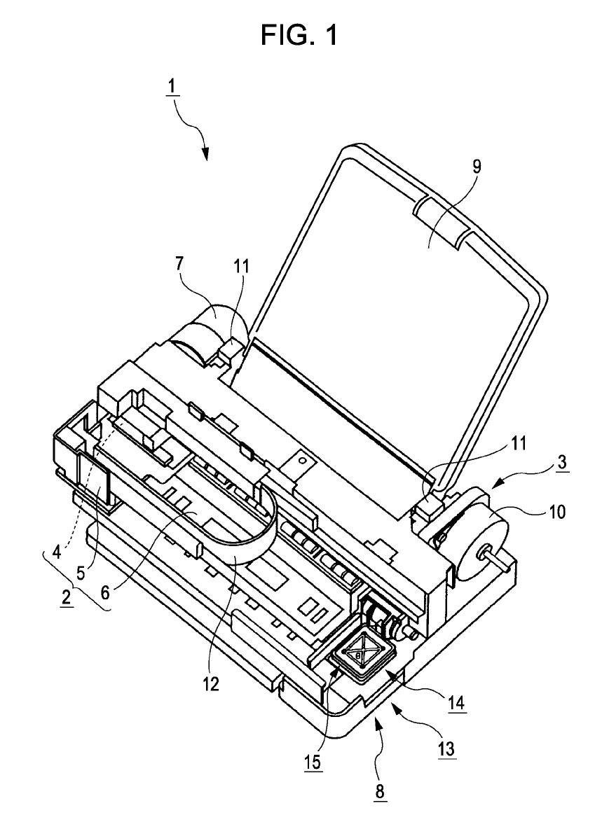

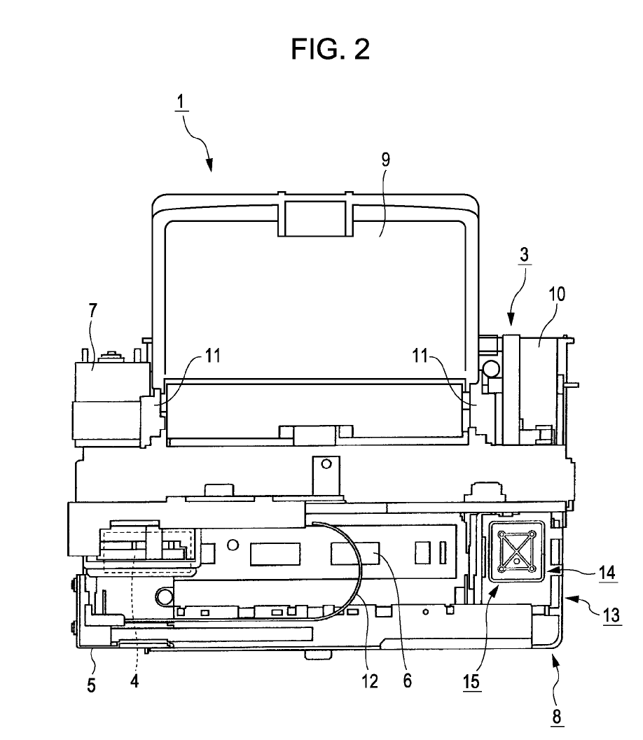

A first embodiment will now be described. FIG. 1 is a perspective view showing an example of a fluid ejecting apparatus according to the first embodiment. FIG. 2 is a plan view of the fluid ejecting apparatus. In this embodiment, a case where the fluid ejecting apparatus is a liquid ejecting apparatus that ejects liquid such as ink will be described as an example. In this embodiment, a case where the fluid ejecting apparatus is an ink jet-type recording apparatus that ejects ink onto a recording medium from an ejection nozzle of a record head and performs record for the recording medium will be described as an example. In this embodiment, as an example of the ink jet-type recording apparatus, an ink jet printer that performs record for a recording sheet by discharging (ejecting) ink droplets onto the recording sheet, which is a recording medium, will be described.

In FIGS. 1 and 2, the ink jet printer 1 includes a record unit 2 that performs record with ink for a recording sheet and a recording sheet transporting mechanism 3 that transports the recording sheet.

The record unit 2 includes a record head 4 that ejects ink, a carriage 5 that can be moved while supporting the record head 4, and a platen 6 that is disposed in a position for facing the record head 4 and the carriage 5 and supports a recording sheet onto which ink is ejected.

In addition, the ink jet printer 1 includes a carriage driving device 7 that includes a motor for moving the carriage 5 and the like and a carriage guiding member that guides movement of the carriage 5. The carriage 5 is moved in a main scanning direction by the carriage driving device 7 while being guided by the carriage guiding member. The recording sheet is moved in a sub scanning direction, which intersects the main scanning direction, with respect to the record unit 2 by the recording sheet transporting mechanism 3.

In addition, the ink jet printer 1 includes a detection system 8 that can detect an ejection state of the record head 4 and ink ejected from the record head 4. In this embodiment, the detection system 8 can detect information on the viscosity of ink ejected from the record head 4.

The ink jet printer 1 includes a paper feeding cassette 9 that houses recording sheets. The paper feeding cassette 9 is provided to be detachably attached to the rear side of the main body of the ink jet printer 1. The paper feeding cassette 9 can house a plurality of stacked recording sheets.

The recording sheet transporting mechanism 3 has a paper feed roller for carrying out a recording sheet of the paper feeding cassette 9, a paper feed roller driving device 10 that includes a motor and the like for driving the paper feed roller, a recording sheet guiding member 11 that guides movement of a recording sheet, a transport roller that is disposed on the downstream side in the transport direction relative to the paper feed roller, a transport roller driving device that drives the transport roller, and a discharge roller that is disposed on the downstream side in the transport direction relative to the record unit 2.

The paper feed roller can pick up a recording sheet placed on the uppermost side from among the plurality of the recording sheets stacked in the paper feeding cassette 9 and carry the paper sheet out of the paper feeding cassette 9. The recording sheet of the paper feeding cassette 9 is sent to the transport roller by the paper feed roller, which is driven by the paper feed roller driving device 10, while being guide by the recording sheet guiding member 11. The recording sheet sent to the transport roller is transported to the record unit 2 disposed on the downstream side in the transport direction by the transport roller driven by the transport roller driving device.

The platen 6 of the record unit 2 is disposed in a position for facing the record head 4 and the carriage 5 and supports the bottom side of the recording sheet. The record head 4 and the carriage 5 are disposed above the platen 6. The recording sheet transporting mechanism 3 transports the recording sheet in the sub scanning direction in association with a record operation performed by the record unit 2. The recording sheet recorded by the record unit 2 is discharged from the front side of the ink jet printer 1 by the recording transporting mechanism 3 including the discharge roller.

In addition, the ink jet printer 1 includes an ink supplying tube 12 that supplies ink of an ink cartridge to the record head 4 of the carriage 5. The ink of the ink cartridge is supplied to an ink supply path through an ink supply needle and is supplied to the record head 4 of the carriage 5 through the ink supplying tube 12 from the ink supply path.

In addition, the ink jet printer 1 includes a maintenance device 13 that can perform a maintenance operation for the record head 4. The maintenance device 13 includes a capping device 14 and a wiping device 15. The maintenance device 13 is disposed in a home position of the carriage 5 and the record head 4. The home position is set as an area of an end portion of a recording area on the outer side, in which a recording operation is performed by the record unit 2, within a movement area of the carriage 5. When the power is turned off or a recording operation is not performed for a long time, the carriage 5 and the record head 4 are disposed in the home position.

In this embodiment, at least a part of the detection system 8 that can detect the ejection state of the record head 4 and the ink ejected from the record head 4 is disposed in the maintenance device 13 (the capping device 14).

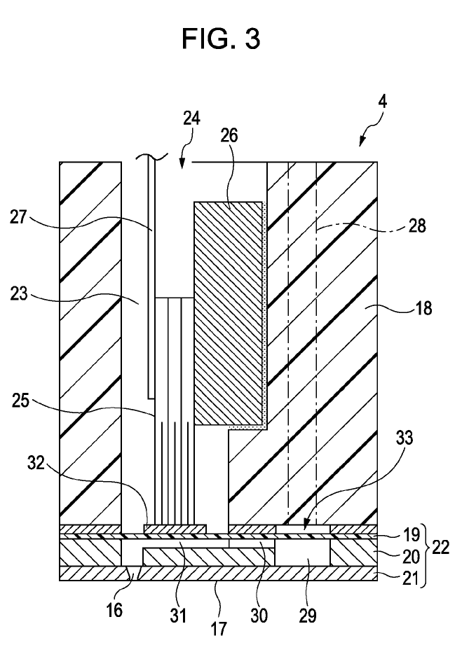

FIG. 3 is a cross-sectional view showing a part of the record head 4. The record head 4 has an ejection face 17 in which an ejection nozzle 16 for ejecting ink is formed. In this embodiment, the ejection nozzle 16 can emit ink droplets. A plurality of the ejection nozzles 16 is formed in the ejection face 17 in a predetermined direction with a predetermined gap interposed therebetween.

The record head 4 includes a flow path forming unit 22 that includes a head main body 18, a diaphragm 19, a flow path substrate 20, and a nozzle substrate 21. The ejection face 17 is formed by the bottom side of the nozzle substrate 21. The ejection nozzle 16 is formed in the nozzle substrate 21. The flow path forming unit 22 is formed by laminating the diaphragm 19, the flow path substrate 20, and the nozzle substrate 21 and bonding them together using a bonding agency or the like as an integral body.

The record head 4 has a housing space 23 formed inside the head main body 18 and a driving unit 24 that is disposed in the housing space 23. The driving unit 24 has a plurality of piezoelectric elements 25, a fixing member 26 that supports the upper end of the piezoelectric elements 25, and a flexible cable 27 that supplies a driving signal to the piezoelectric elements 25. The piezoelectric elements 25 are provided in correspondence with a plurality of ejection nozzles 16.

In addition, the record head 4 is formed inside the head main body 18 and includes an internal flow path 28 through which ink supplied from the ink cartridge through the ink supply tube 12 flows, and a common ink chamber 29 that is formed by the flow path forming unit 22 including the diaphragm 19, the flow path substrate 20, and the nozzle substrate 21 and is connected to the internal flow path 28, an ink supply opening 30 that is formed by the flow path forming unit 22 and is connected to the common ink chamber 29, and a pressure chamber 31 that is formed by the flow path forming unit 22 and is connected to the ink supply opening 30. A plurality of the pressure chambers 31 is provided in correspondence with the plurality of the ejection nozzles 16. The plurality of the ejection nozzles 16 is connected to the plurality of the pressure chambers 31.

The head main body 18 is formed of a synthetic resin. The diaphragm 19, for example, is formed by performing a laminating process for an elastic film on a support substrate made of metal such as stainless steel. In a portion of the diaphragm 19 which corresponds to the pressure chamber 31, an insular part 32 that is bonded to the lower end of the piezoelectric element 25 is formed. At least a part of the diaphragm 19 is elastically transformed in accordance with driving the piezoelectric element 25. Between the diaphragm 19 and a portion of the internal flow path 28 near its lower end, a compliance part 33 is formed.

The flow path substrate 20 has the common ink chamber 29 that connects the lower end of the internal flow path 28 and the ejection nozzle 16 and a concave portion for forming space for the ink supply opening 30 and the pressure chamber 31. In this embodiment, the flow path substrate 20 is formed by performing an anisotropic etching process for silicon.

The nozzle substrate 21 has a plurality of ejection nozzles 16 formed in a predetermined direction to have a predetermined gap (pitch) therebetween. In this embodiment, the nozzle substrate 21 is a plate-shaped member formed of metal such as stainless steel.

The ink supplied from the ink cartridge through the ink supply tube 12 flows in the upper end of the internal flow path 28. The lower end of the internal flow path 28 is connected to the common ink chamber 29. The ink flowing in the upper end of the internal flow path 28 from the ink cartridge through the ink supply tube 12 flows through the internal flow path 28, and then is supplied to the common ink chamber 29. The ink supplied to the common ink chamber 29 is supplied so as to be distributed to the plurality of the pressure chambers 31 through the ink supply opening 30.

When a driving signal is input to the piezoelectric element 25 through the cable 27, the piezoelectric element 25 expands or contracts. Accordingly, the diaphragm 19 is transformed (moved) in a direction for approaching or receding from the pressure chamber 31. Accordingly, the volume of the pressure chamber 31 changes, and thereby the pressure in the pressure chamber 31 housing the ink changes. In accordance with the change in the pressure, ink is ejected (discharged) from the ejection nozzle 16.

As described above, in this embodiment, the piezoelectric element (driving element) 25 changes the pressure in the pressure chamber (space) 31 connected to the ejection nozzle 16 based on the driving signal input for ejecting ink from the ejection nozzle 16.

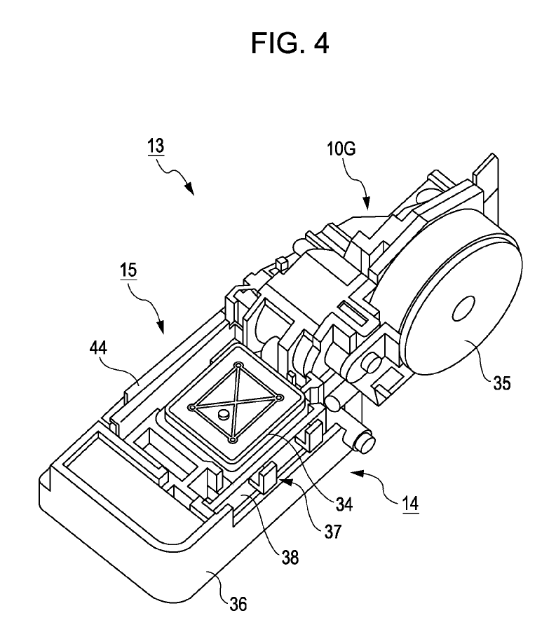

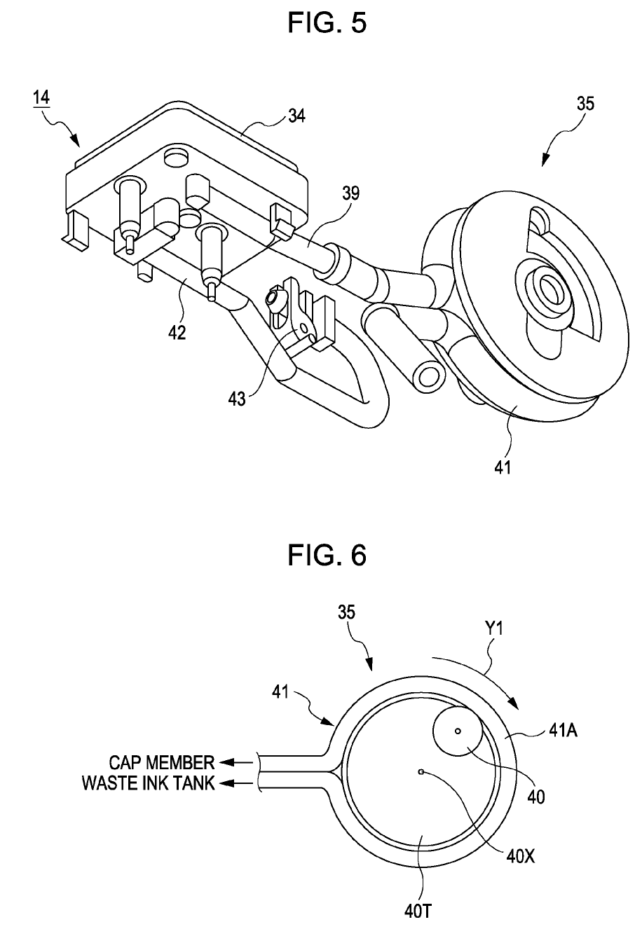

FIG. 4 is a perspective view showing the maintenance device 13. FIG. 5 is a perspective view of a part of the inside of the maintenance device 13 viewed from the lower side. The maintenance device 13 includes the capping device 14 and the wiping device 15.

In FIGS. 4 and 5, the capping device 14 has a capping member 34 that can face the ejection face 17 of the record head 4. The cap member 34 can cover the ejection face 17. In addition, the cap member 34 can form a space between the ejection face 17 and the cap member.

In addition, the capping device 14 has a base member 36 and a driving mechanism 37 that moves the cap member 34 in a direction for approaching or receding from the ejection face 17 of the record head 4 disposed in the home position. The driving mechanism 37 includes a slider member 38 that is, for example, mounted on a base member 36 as disclosed in Japanese Unexamined Patent Application Publication Number 2006-272779 and the like and guides and moves the cap member 34 in the direction for approaching or receding from the ejection face 17, a spring member disposed between the base member 36 and the slider member 38, and the like.

In addition, the capping device 14 has a suction device 35 that can suck fluid in the space formed between the cap member 34 and the ejection face 17. As shown in FIG. 5, the capping device 14 has a suction tube 39 that is connected to the bottom of the cap member 34, and the suction device 35 is connected to the suction tube 39. In this embodiment, the suction device 35 includes, for example, a tube pump disclosed in Japanese Unexamined Patent Application Publication Number 2004-314622 and the like.

FIG. 6 is a diagram showing an example of the suction device 35. In FIG. 6, the suction device 35 has a roller member 40 and a tube member 41. The tube member 41 has flexibility and is curved in the shape of a ring. Both ends of the tube member 41 are disposed so as to be drawn out in a same direction. One end of the tube member 41 is connected to the cap member 34 with the suction tube 39 interposed therebetween, and the other end of the tube member 41 is connected to a waste ink tank not shown in the figure. The roller member 40 can be moved so as to roll on the inner periphery of a ring-shaped portion 41A of the tube member 41.

The suction device 35 has a rotation disc 40T that supports the roller member 40 to be rotatable and can rotate around a rotation axis 40X and a driving device that rotates the rotation disc 40T. In this embodiment, the driving device that rotates the rotation disc 40, for example, includes the paper feed roller driving device 10 of the recording sheet transporting mechanism 3. The power of the paper feed roller driving device 10 is transferred to the rotation disc 40T through a gear unit 10G provided in the suction device 35. As the rotation disc 40T rotates, the roller member 40 revolves so as to roll along the inner periphery of the ring shaped-portion 40A of the tube member 41.

As the roller member 40 moves (rotates), for example, in a direction of arrow Y1 shown in FIG. 6 while pressing the tube member 41, the fluid (air, ink, and the like) inside the tube member 41 is squeezed out on the other end side (the waste ink tank side) of the tube member 41. In other words, by rotating the roller member 40, the fluid inside the tube member 41 on one end side (the cap member side) moves to the other end side. Accordingly, the suction device 35 can make the space formed between the ejection face 17 and the cap member 34 have a negative pressure through the suction tube 39.

By making the space between the ejection face 17 and the cap member 34 to have a negative pressure, ink can be sucked from the ejection nozzle 16 of the ejection face 17 or ink in the space can be discharged outside the space (the waste ink tank) through the suction tube 39 and the tube member 41 of the suction device 39.

In addition, the roller member 40 may be moved to be apart from the tube member 41, so that the roller member 40 does not press the tube member 41.

In addition, as the configuration of the tube pump, instead of using a form in which both ends of the tube member curved in the shape of a ring is drawn out in a same direction so as to form a bundle in a same plane, as shown in FIG. 6, a configuration in which both ends of the tube member curved in the shape of a ring are drawn out in opposite directions so as to intersect each other may be employed. As the suction device 35, for example, a tube pump as disclosed in Japanese Unexamined Patent Application Publication Number 2006-257928 may be used.

As shown in FIG. 5, the capping device 14 has an air opening tube 42 that is connected to the bottom of the cap member 34 and an air opening valve 43 provided in the air opening tube 42. By opening the air opening valve 43, air can be flown into the space formed between the ejection face 17 and the cap member 34 through the air opening tube 42. Accordingly, when the space formed between the ejection face 17 and the cap member 34 is in a negative pressure state by using the suction device 35, by opening the air opening value 43, the space is open to the air, and thereby the negative pressure state of the space is released.

In FIG. 4, the wiping device 15 has a wiping member 44 that can face the ejection face 17 of the record head 4. In this embodiment, the wiping member 44 is disposed in a part of the base member 36. The wiping member 44 is disposed on the record unit 2 side (the recording area side) relative to the cap member 34. The wiping device 15 can wipe out or brush off a foreign material such as remaining ink or the like that is attached to the ejection face 17a by using the wiping member 44.

The ink jet printer 1 can perform a maintenance operation for the record head 4 by using the maintenance device 13. The maintenance device 13, in order to maintain the ejection characteristics of the record head 4, performs a maintenance process including an operation for discharging ink from the ejection nozzle 16 in cooperation with the record head 4.

The maintenance process includes at least one of a flushing operation for ejecting ink to the cap member 34 from the ejection nozzle 16 and a suction operation using the cap member 34 of the capping device 14 and the suction device 35. In addition, the maintenance process includes a wiping process using the wiping device 15. The flushing operation includes an operation for ejecting (discharging) ink from the ejection nozzle 16 to the cap member 34 in the home position in advance before supplying the ink from the ejection nozzle 16 to the recording sheet in the recording area. Accordingly, ink having increased viscosity located near the ejection nozzle 16 is discharged, and thereby the ejection characteristics of the ejection nozzle 16 are maintained or recovered.

The suction operation includes an operation for sucking ink from the ejection nozzle 16 of the ejection face 17 by disposing the ejection face 17 and the cap member 34 to face each other in the home position and making the space formed between the ejection face 17 and the cap member 34 to have a negative pressure using the suction device 35. Accordingly, ink having increased viscosity that is not discharged by the flushing operation, dusts penetrated inside the ejection nozzle 16, an air bubble inside the record head 4, and the like are discharged together with the ink from the ejection nozzle 16, and thereby the ejection characteristics of the ejection nozzle 16 are maintained or recovered.

The wiping operation includes an operation for wiping the ejection face 17 using the wiping member 44 in the home position by disposing the ejection face 17 and the wiping member 44 to face each other. Accordingly, a foreign material (including remaining ink) attached to the ejection face 17 including the ejection nozzle 16 is removed, and thereby the ejection characteristics of the ejection nozzle 16 are maintained or recovered.

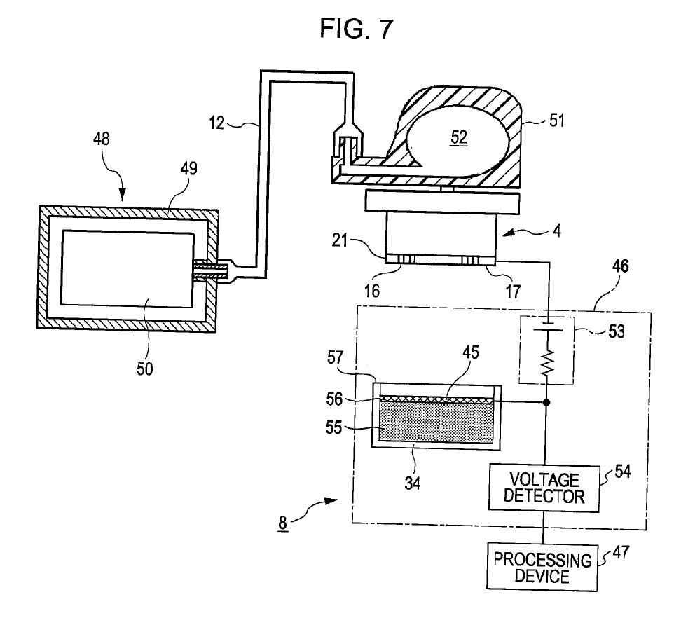

FIG. 7 is a schematic diagram for describing a detection system 8. The detection system 8 can detect the state of ink ejection of the ejection nozzle 16 of the record head 4 and ink ejected from the ejection nozzle 16 of the record head 4. In addition, the detection system 8 can detect information on the viscosity of the ink ejected from the ejection nozzle 16 of the record head 4.

In FIG. 7, the ink supply tube 12 connects the ink cartridge 48 and a sub tank 51 connected to the record head 4 together, and the ink supplied to the ink supply tube 12 from the ink cartridge 48 is supplied to the sub tank 51. In this embodiment, the ink cartridge 48 includes a case member 49 and an ink pack 50 that is housed in the case member 49 and is formed of a plastic material. The sub tank 51 has an ink chamber 52, and the ink supplied to the ink chamber 52 is supplied to the record head 4.

In FIG. 7, the detection system 8 has a detection device 46 that has a detection unit 45, which is disposed to face the ejection face 17 of the record head 4 with a predetermined gap interposed therebetween and to which ink ejected from the ejection nozzle 16 is supplied, and outputs a detection signal on the basis of the ink ejected from the ejection nozzle 16 and a processing device 47 that acquires information on the viscosity of ink on the basis of the detection signal output from the detection device 46.

The detection device 46 has a voltage application unit 53 that applies a voltage between the detection unit 45 and the ejection face 17 of the record head 4 and a voltage detector 54 that detects the voltage of the detection unit 45.

In this embodiment, the detection unit 45 of the detection device 46 is disposed inside the cap member 34 of the maintenance device 13 (the capping device 14) that is disposed in the home position. In other words, in this embodiment, the maintenance device 13 (the capping device 14) includes the detection unit 45 of the detection device 46.

The cap member 34 is a member in the shape of a tray having an opening in its upper part and is formed of an elastic member such as an elastomer. On the inner side of the cap member 34, an ink absorption body 55 and an electrode member 56 are disposed. The electrode member 56 is formed of a mesh member (a lattice-shaped member) formed of metal such as stainless steel. The detection unit 45 is formed by the upper face of the electrode member 56. The detection unit 45 is disposed in a position lower than that of the upper end face 57 of the cap member 34. The upper end face 57 is a face of the cap member 34 that is closest to the ejection face 17. The detection unit 45 is disposed in a position slightly farther than the upper end face 57 from the ejection face 17.

The ink absorption body 55 is formed of a sponge-shaped member, a porous member, or the like that can maintain (absorb) ink. In this embodiment, the ink absorption body 55 is formed of a non-woven cloth such as pelt. In a non-recording process, ink absorbed by the ink absorption body 55 moisturizes inside a space formed by bring the ejection face 17 and the cap member 34 into contact with each other, and thereby dryness of ink inside the ejection nozzle 16 is suppressed. In addition, ink may perform a moisture absorbing action depending on the type of the ink. In such a case, the ink absorption body is not necessary. In other words, the ink absorption body is disposed as is needed.

The ink supplied to the detection unit 45 passes through an electrode gap of the electrode member 56 and is maintained (absorbed) by the ink absorption body 55. The electrode member 56 may not a mesh member as long as it can pass the ink. When the ink absorption body 55 is not provided, the electrode member 56 is maintained by a rib disposed to extend from the bottom face of the cap member 34. As described above, to the bottom of the cap member 34, the suction tube 39 is connected. The ink of the ink absorption body 55 is sucked by the suction device 35 through the suction tube 39.

The voltage application unit 53 includes an electronic circuit that can apply a voltage between the ejection side (lower side) 17 of the nozzle substrate 21 of the record head 4 and the detection unit (upper side) 45 of the electrode member 56. In this embodiment, the voltage application unit 53 electrically connects the electrode member 56 and the nozzle substrate 21 with a DC power source and a resistor interposed therebetween such that the electrode member 56 becomes a positive electrode and the nozzle substrate 21 becomes a negative electrode.

As described above, the nozzle substrate 21 is formed of metal such as stainless steel, the electrode member 56 is formed of metal such as stainless steel, and the nozzle substrate 21 and the electrode member 56 have conductivity. The voltage application unit 53 can apply a voltage between the ejection face 17 and the detection unit 45.

The voltage detection unit 54 includes an integral circuit that integrates a voltage signal of the electrode member 56 and outputs a resultant signal, an inverted amplifier circuit that performs an inverted amplification operation for the signal output from the integral circuit and outputs a resultant signal, an A/D conversion circuit that performs an A/D conversion operation for the signal output from the inverted amplifier circuit and outputs a resultant signal, and the like.

In this embodiment, the detection device 46 supplies an electric field between the ejection face 17 and the detection unit 45 and outputs a change in a voltage value with respect to time based on electrostatic induction when the ink is moved from the ejection nozzle 16 to the detection unit 45 to the processing device 47 as a detection signal. The processing device 47 can perform a calculation process for the output of the detection device 46 and can acquire information on the viscosity of the ink on the basis of the detection signal output from the detection device 46.

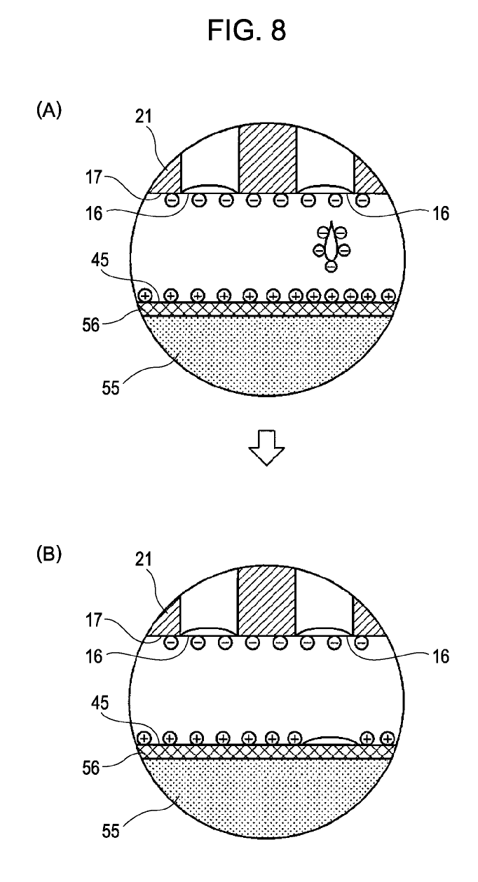

FIG. 8 is a schematic diagram for describing a principle of the detection operation of the detection device 46. By driving the piezoelectric element 25 in a state that a voltage is applied between the ejection nozzle 17 of the nozzle substrate 21 and the detection unit 45 of the electrode member 56 by the voltage application unit 53, ink droplets are ejected (discharged) from the ejection nozzle 16. In this embodiment, since the nozzle substrate 21 is a negative electrode, as shown in FIG. 8(A), a part of negative charges of the nozzle substrate 21 is moved as ink droplets, and thereby the ejected ink droplets are negatively charged. As the ink droplets ejected from the ejection nozzle 16 approaches the detection unit 45 of the electrode member 56, positive charges generated by electrostatic induction increase in the detection unit 45. Accordingly, the voltage value between the ejection face 17 of the nozzle substrate 21 and the detection unit 45 of the electrode member 56 becomes higher than its initial voltage value in a state that the ink droplets are not ejected, due to an induction voltage generated by the electrostatic induction. Thereafter, as shown in FIG. 8(B), when the ink droplets contact the detection unit 45, the positive charges of the detection unit 45 are neutralized by the negative charges of the ink droplets. As a result, the voltage value between the ejection face 17 of the nozzle substrate 21 and the detection unit 45 of the electrode member 56 becomes lower than its initial voltage value. Thereafter, the voltage value between the ejection face 17 of the nozzle substrate 21 and the detection unit 45 of the electrode member 56 returns to its initial voltage value.

Here, in descriptions below, a voltage value (initial voltage value) applied between the ejection face 17 and the detection unit 45 which is detected at a time when ink is not ejected from the ejection nozzle 16 in a state that an electric field is supplied between the ejection face 17 and the detection unit 45 is appropriately referred to as a reference value V0.

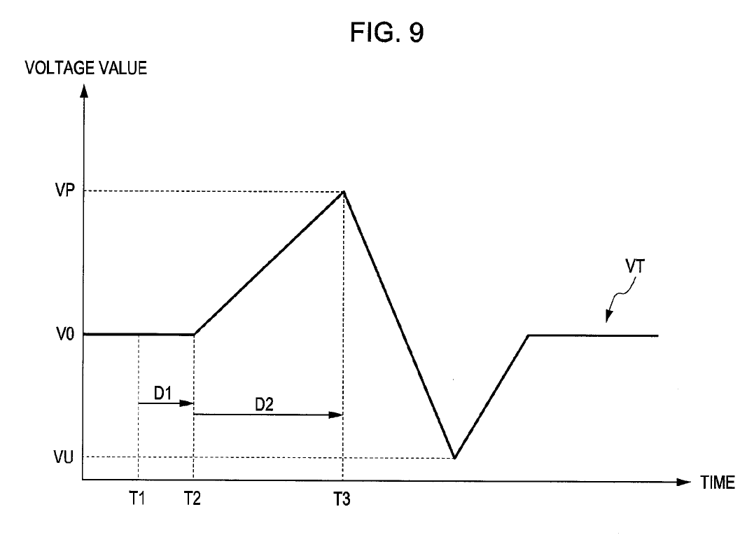

FIG. 9 is a diagram showing an example of a change (detection signal) VT in the voltage value with respect to time which is output from the voltage detector 54 of the detection device 46 at a time when ink droplets are ejected (discharged) from the ejection nozzle 16 in a state that a voltage is applied between the ejection face 17 and the detection unit 45 and an electric field is supplied between the ejection face 17 and the detection unit 45. In FIG. 9, the horizontal axis denotes a time, and the vertical axis denotes a voltage value.

As shown in FIG. 9, the detection signal VT includes voltage values for each of a first time T1, a second time T2 after a first period of time D1 has passed from the first time T1, and a third time T3 after a second period of time D2 has passed from the second time T2.

The voltage value from the first time T1 to the second time T2 is the reference value V0. At the second time T2, the voltage value starts to change. At the third time T3, the voltage value becomes an extreme value (maximum value) VP.

In the detection signal VT shown in FIG. 9, the first time T1 is a time when a driving signal is input to the driving element 25. The second time T2 is a time when ejection (discharge) of ink droplets from the ejection nozzle 16 is started. The third time T3 is a time when the ink droplets from the ejection nozzle 16 reach (contact) the detection unit 45.

When a driving signal is input to the piezoelectric element 25 at the first time T1 for ejecting (discharging) ink droplets from the ejection nozzle 16, a change in the pressure of the pressure chamber 31 connected to the ejection nozzle 16 is started. After the driving signal is input to the piezoelectric element 25 at the first time T1, the pressure of the pressure chamber 31 reaches a predetermined value, and ejection (discharge) of the ink droplets from the ejection nozzle 16 is started at the second time T2 after the first period of time D1 passes. In other words, in a case where the ink droplets from the ejection nozzle 16 are moved from the ejection face 17 to the detection unit 45, the second time T2 is a moment when movement of the ink droplets is started.

As described with reference to FIG. 8, the ink droplets ejected from the ejection nozzle 16 are negatively charged. At the moment when ejection of the ink droplets from the ejection nozzle 16 is started, that is, when the ink droplets depart from the ejection nozzle 16, the voltage value starts to change.

As the ink droplets ejected from the ejection nozzle 16 approach the detection unit 45 of the electrode member 56 after ejection of the ink droplets from the ejection nozzle 16 is started, as described with reference to FIG. 8, positive charges in the detection unit 45 increases due to electrostatic induction. Owing to the induction voltage generated by the electrostatic induction, the voltage value slowly increases. Then, at the third time T3 when the ink droplets from the ejection nozzle 16 reach (contact) the detection unit 45, the voltage value becomes the maximum value VP.

Thereafter, as described with reference to FIG. 8, when the ink droplets contact the detection unit 45, the positive charges of the detection unit 45 are neutralized by the negative charges of the ink droplets. As a result, after the third time T3, the voltage value slowly decreases. Then, at the fourth time after a predetermined time passes from the third time T3, the voltage value becomes smaller than the reference value V0 to be the minimum value VU. Then, the voltage value returns to the reference value V0.

The detection signal VT of the detection device 46 is output to the processing device 47. The processing device 47 acquires the first period of time D1, the second period of time D2, the reference value V0, and the maximum value VP based on the detection signal VT output from the detection device 46. The processing device 47 acquires at least one of the first period of time D1, the second period of time D2, and a difference between the reference value V0 and the extreme value VP (the maximum value VP with respect to the reference value V0), and acquires information on the viscosity of the ink based on the acquired result.

The first period of time D1, the second period of time D2, and the maximum value VP with respect to the reference value V0 change in accordance with the viscosity of the ink ejected from the ejection nozzle 16.

For example, when the viscosity of the ink ejected from the ejection nozzle 16 is higher than that of the ink in the initial state, the first period of time D1 from the first time T1 when the driving signal is input to the piezoelectric element 25 to the second time T2 that is a moment when the pressure of the pressure chamber 31 becomes a predetermined value and the ink droplets are ejected from the ejection nozzle 16 is lengthened.

In other words, in a case where ink is ejected based on a predetermined driving force of the piezoelectric element 25 (the driving unit 24), when the viscosity of the ink is high, it is difficult to eject the ink. On the other hand, when the viscosity of the ink is low, it is easy to eject the ink. In the case where ink is ejected based on a predetermined driving force of the piezoelectric element 25 (the driving unit 24), when the viscosity of the ink is increased from that in the initial state, it is difficult to eject the ink, and accordingly, the first period of time D1 from a time when the driving signal is input to the piezoelectric element 25 to a time when the ink is ejected from the ejection nozzle 16 is lengthened.

In addition, when the viscosity of the ink ejected from the ejection nozzle 16 is higher than that of the ink in the initial state, the second period of time D2 from the second time T2 when the ejection of the ink droplets from the ejection nozzle 16 is started to the third time T3 that is a moment when the ink from the ejection nozzle 16 reaches the detection unit 45 is lengthened.

In other words, in a case where ink is ejected based on a predetermined driving force of the piezoelectric element 25 (the driving unit 24), when the viscosity of the ink is high, moving speed (flying speed of the ink droplets) of the ink between the ejection face 17 and the detection unit 45 decreases. On the other hand, when the viscosity of the ink is low, moving speed (flying speed of the ink droplets) of the ink increases. In the case where ink is ejected based on a predetermined driving force of the piezoelectric element 25 (the driving unit 24), when the viscosity of the ink is increased from that in the initial state, the moving speed (flying speed of the ink droplets) of the ink decreases, and accordingly, the second period of time D2 from a time when the ink is ejected from the ejection nozzle 16 to a time when the ink reaches the detection unit 45 is lengthened.

In addition, when the viscosity of the ink ejected from the ejection nozzle 16 is higher than that of the ink in the initial state, the maximum value VP with respect to the reference value V0 decreases.

In other words, the maximum value VP with respect to the reference value V0 changes in accordance with the amount of ink (a size or volume of one ink droplet) ejected from the ejection nozzle 16. When the size of the ink droplet is large, the maximum value VP increases. On the other hand, when the size of the ink droplet is small, the maximum value VP decreases. In a case where ink is ejected based on a predetermined driving force of the piezoelectric element 25 (the driving unit 24), when the viscosity of the ink is increased from that in the initial state, it is difficult to eject the ink, and accordingly, the size (volume) of one ink droplet decreases. As a result, the maximum value VP with respect to the reference value V0 decreases.

As described above, in this embodiment, by ejecting ink droplets from the ejection nozzle 16 in a state that a voltage is applied between the ejection face 17 and the detection unit 45 and an electric field is supplied between the ejection face 17 and the detection unit 45, the detection unit 46 can output a change (detection signal) VT of the voltage value with respect to time on the basis of electrostatic induction that occurs at a time when the ink moves from the ejection nozzle 16 to the detection unit 45.

Then, the processing device 47 can acquire information on the viscosity of the ink ejected from the ejection nozzle 16 based on the detection signal VT output from the detection device 46, and more particularly, at least one of the first period of time D1, the second period of time D2, and a difference between the reference value V0 and the maximum value VP.

In addition, the information on the viscosity of the ink ejected from the ejection nozzle 16 can be acquired, for example, based on a difference between the reference value V0 and the minimum value VU instead of the first period of time D1, the second period of time D2, and the difference between the reference value V0 and the maximum value VP. As described above, the amount (a size or volume of one ink droplet) of ink ejected from the ejection nozzle 16 changes depending on the viscosity of the ink. Since the minimum value VU with respect to the reference value V0 changes depending on the amount of the ink, the information on the viscosity of the ink ejected from the ejection nozzle 16 can be acquired based on the difference between the reference value V0 and the minimum value VU.

When ink is ejected from the ejection nozzle 16, the detection signal VT output from the detection device 46 changes. Accordingly, the detection system 8 can determine the state of ink ejection of the ejection nozzle 16 including whether ink is ejected from the ejection nozzle 16 of the record head 4 (whether there is a ejection defect or not) based on the detection signal VT output from the detection device 46.

When the ink ejected from the ejection nozzle 16 contacts (reaches) the detection unit 45, the detection signal VT output from the detection device 46 changes. Accordingly, the detection system 8 can detect the ink ejected from the ejection nozzle 16 of the record head 4 based on the detection signal VT output from the detection device 46. In addition, the detection system 8 can detect the amount (the size or volume of an ink droplet) of the ink ejected from the ejection nozzle 16 based on the detection signal VT (the extreme value VP).

Here, the first period of time D1 and the extreme value VP of the detection signal VT output from the detection device 46 also change depending on the driving state (including a driving force, a driving signal, and a driving waveform) of the driving unit 24 including the piezoelectric element 25. Accordingly, the detection system 8 performs an operation for acquiring information on the viscosity of the ink in a state that the driving state of the driving unit 24 is constantly maintained.

In addition, the second period of time D2 of the detection signal VT output from the detection device 46 also changes depending on a distance between the ejection face 17 and the detection unit 45. Accordingly, the detection system 8 performs the operation for acquiring information on the viscosity of the ink in a state that the distance (gap) between the ejection face 17 and the detection unit 45 is constantly maintained.

In other words, when performing an operation for acquiring the information on the viscosity of the ink, the detection system 8 sets ejection conditions for ejecting ink from the ejection nozzle 16 to be the same all the time for performing the operation.

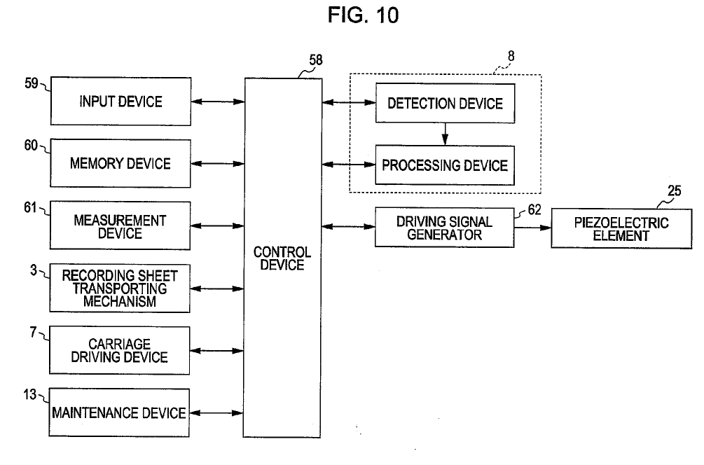

FIG. 10 is a block diagram showing the electrical configuration of the ink jet printer 1. The ink jet printer 1 according to this embodiment has a control device 58 that controls the overall operation of the ink jet printer 1. To the control device 58, an input device 59 that receives various types of information on the operation of the ink jet printer 1, a memory device 60 that stores various types of information on the operation of the ink jet printer 1, and a measurement device 61 that can perform a measurement operation for time are connected. In addition, to the control device 58, the recording sheet transporting mechanism 3, the carriage driving device 7, the maintenance device 13, the detection system 8 (the detection device 46 and the processing device 47), and the like which have been described above are connected.

The measurement device 61 measures an elapsed time t from a reference time and can output the measured value. The control device 53 controls the maintenance device 13 in accordance with the measured value output from the measurement device 61. In this embodiment, the control device 58 performs a maintenance process for the record head 4 at a predetermined timing by using the maintenance device 13. The reference time includes a completion time of a maintenance process that is performed first (previously).

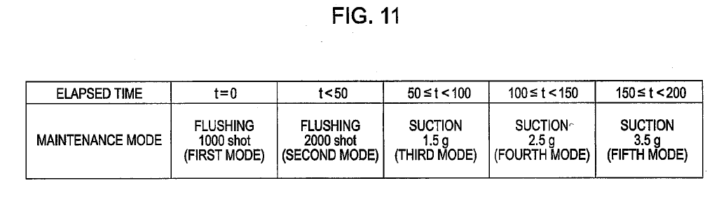

In the memory device 60, a timer cleaning table as shown in FIG. 11 is stored. The timer cleaning table includes information on the contents (maintenance modes) of a plurality of maintenance processes set in correspondence with an elapsed time t from a maintenance process performed previously for solving an ejection defect of the ejection nozzle 16.

The timer cleaning table is data, for example, acquired in advance from experiments or simulation of an environment test in a manufacturing process of the ink jet printer 1 or the like in a manufacturing factory or the like and is stored in the memory device 60 in advance at a shipping time from a manufacturing factory or the like.

In order to solve the ejection defect of the ejection nozzle 16, for example, in a worst condition (for example, a high-temperature and low-humidity condition such as a condition at temperature of 40° C. and humidity of 10%) of use environment that can be considered for the ink jet printer 1, the timer cleaning table includes information on a plurality of contents (maintenance modes) of the maintenance process set in correspondence with an elapsed time t from a maintenance process performed previously.

In this embodiment, the maintenance process includes a flushing operation and a suction operation that are operations for discharging ink from the ejection nozzle 16. In this embodiment, the maintenance device 13 can perform a maintenance process in a plurality of maintenance modes having different discharge amounts of ink discharged from the ejection nozzle 16. In the timer cleaning table, the plurality of different maintenance modes having different discharge amounts of ink discharged from the ejection nozzle 16 are set in correspondence with an elapsed time t.

In the timer cleaning table shown in FIG. 11, as an example, a flushing operation for discharging 2000 ink droplets is set as a maintenance process in correspondence with a case where the elapsed time t from the maintenance process performed previously is less than 50 hours. When the elapsed time t is less than 50 hours, the ejection defect of the ejection nozzle 16 can be solved even in the worst condition by performing the flushing operation for discharging 2000 ink droplets, which is verified by an environment test or the like. In this embodiment, when the elapsed time t is 0, a flushing operation for discharging 1000 ink droplets is performed.

Similarly, a suction operation for sucking ink of 1.5 g is set in correspondence with a case where the elapsed time t is equal to or more than 50 hours and is less then 100 hours. In addition, a suction operation for sucking ink of 2.5 g is set in correspondence with a case where the elapsed time t is equal to or more than 100 hours and is less than 150 hours, and a suction operation for sucking ink of 3.5 g is set in correspondence with a case where the elapsed time t is equal to or more than 150 hours and is less then 200 hours.

Here, in a description below, a maintenance mode including the flushing operation for discharging 1000 ink droplets is appropriately referred to as a first mode, and a maintenance mode including the flushing operation for discharging 2000 ink droplets is appropriately referred to as a second mode. In addition, a maintenance mode including the suction operation for sucking ink of 1.5 g is appropriately referred to as a third mode, a maintenance mode including the suction operation for sucking ink of 2.5 g is appropriately referred to as a fourth mode, and a maintenance mode including the suction operation for sucking ink of 3.5 g is appropriately referred to as a fifth mode.

As shown in FIG. 10, the ink jet printer 1 has a driving signal generator 62 that generates a driving signal to be input to the driving unit 24 including the piezoelectric element 25. The driving signal generator 62 is connected to the control device 58.

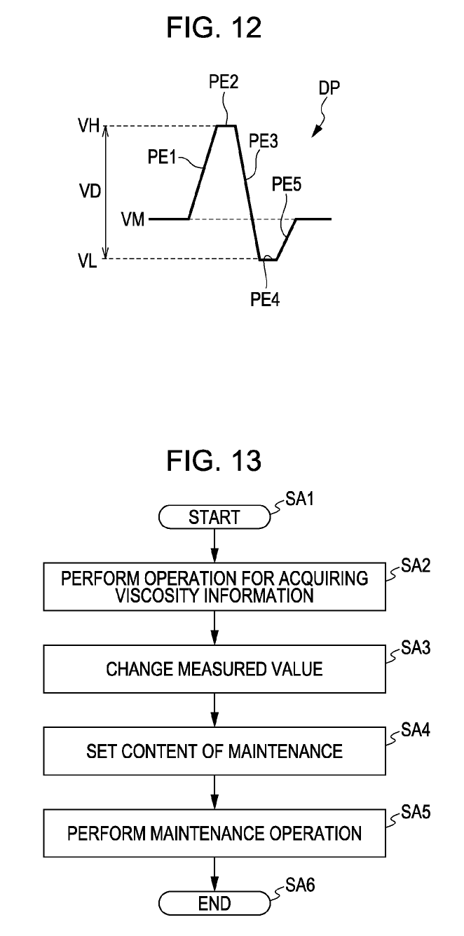

To the driving signal generator 62, data indicating the amount of a change in a voltage value of a discharge pulse input to the piezoelectric element 25 of the record head 4 and a timing signal that defines a timing for changing the voltage of the discharge pulse are input. The driving signal generator 62 generates a driving signal including a discharge pulse DP, for example, shown in FIG. 12 based on the data and the timing signal that have been input.

In FIG. 12, the discharge pulse DP includes a first charge element PE1 that increases the electric potential at a predetermined gradient from a reference electric potential VM to a highest electric potential VH, a first hold element PE2 that maintains the highest electric potential VH for a fixed time, a discharge element PE3 that decreases the electric potential at a predetermined gradient from the highest electric potential VH to a lowest electric potential VH, a second hold element PE4 that maintains the lowest electric potential VL for a short time, and a second charge element PE5 that returns the electric potential from the lowest electric potential VL to the reference electric potential VM. A driving voltage VD that is an electric potential difference between the highest and lowest electric potentials VH and VL of the discharge pulse DP such that the amount of ink droplets ejected from the ejection nozzle 16 is identical to a designed value. The discharge pulse DP shown in FIG. 12 is an example, and various waveforms may used as the discharge pulse.

When the discharge pulse DP is input from the driving signal generator 62 to the piezoelectric element 25, ink droplets are discharged from the ejection nozzle 16. When the first charge element PE1 is supplied, the piezoelectric element 25 contracts and the pressure chamber 31 expands. After the expansion state of the pressure chamber 31 is maintained for a short time, the discharge element PE3 is supplied, and the piezoelectric element 25 rapidly expands. Accordingly, the volume of the pressure chamber 31 decreases to be equal to or less than a reference volume (the volume of the pressure chamber 31 in a case where the reference electric potential VE is applied to the piezoelectric element 25), and a meniscus exposed to the ejection nozzle 16 is rapidly pressed toward the outer side. Accordingly, ink droplets of a predetermined amount are discharged from the ejection nozzle 16. Thereafter, the second hold element PE4 and the second charge element PE5 are sequentially supplied to the piezoelectric element 25, and the volume of the pressure chamber 31 is returned to the reference volume for converging vibration of the meniscus which is accompanied by the discharge of the ink droplets.

Next, an example of the operation of the ink jet printer 1 having the above-described configuration will be described with reference to a flow chart shown in FIG. 13, with the operation of the detection system 8 and the maintenance device 13 mainly focused.

The control device 58 directs to start a detection operation using the detection system 8 at a predetermined timing (Step SA1). The operations (recording operations) for supplying ink from the ejection nozzle 16 to a plurality of recording sheets are sequentially performed. In this embodiment, the control device 58 performs a detection operation using the detection system 8 before supplying the ink from the ejection nozzle 16 to a recording sheet.

As described above, in this embodiment, a flushing operation for ejecting ink from the ejection nozzle 16 to the cap member 34 in the home position in advance is performed before the ink from the ejection nozzle 16 is supplied to the recording sheet in the recording area. In this embodiment, the detection system 8 acquires information on the viscosity of ink by using the ink ejected by the flushing operation. In other words, in this embodiment, the detection operation of the detection system 8 is performed for each flushing operation.

In order to detect the information on the viscosity of the ink, the control device 58 disposes the detection unit 45 so as to face the ejection face 17 in the home position with a predetermined gap interposed therebetween. In this embodiment, the control device 58 performs a detection operation using the detection system 8 in a state that the ejection face 17 and the upper end face 57 of the cap member 34 are slightly apart from each other.

Then, the control device 58 performs the operation (viscosity information acquiring operation) for detecting the information on the viscosity of the ink by using the detection system 8 (Step SA2).

In the viscosity information acquiring operation, the control device 58 supplies a driving signal to the driving unit 24 by using the driving signal generator 62 and performs an operation for ejecting ink droplets from one ejection nozzle 16 among a plurality of the ejection nozzles 16. The ink droplets ejected from the ejection nozzle 16 are supplied to the detection unit 45. As described with reference to FIG. 9 and the like, the voltage detector 54 outputs a detection signal on the basis of the ink ejected from the ejection nozzle 16 to the processing device 47. The processing device 47 acquires information on the viscosity of the ink based on the detection signal.

In this embodiment, a reference signal VR to be output from the detection device 46 based on the ink in the initial state is stored in the memory device 60 in advance. The ink in the initial state includes ink having viscosity that has not been increased or ink in an ideal state. Information on the reference signal VR, for example, can be acquired in advance from experiments or simulation in a manufacturing process performed in a manufacturing factory of the ink jet printer 1 or the like. The reference signal VR is stored in the memory device 60 in advance at a time for shipping the ink jet printer from the manufacturing factory or the like.

The processing device 47 acquires information on the amount of change in the viscosity of the ink from its initial state based on the detection signal VT output from the detection device 46 and the reference signal VR stored in the memory device 60.

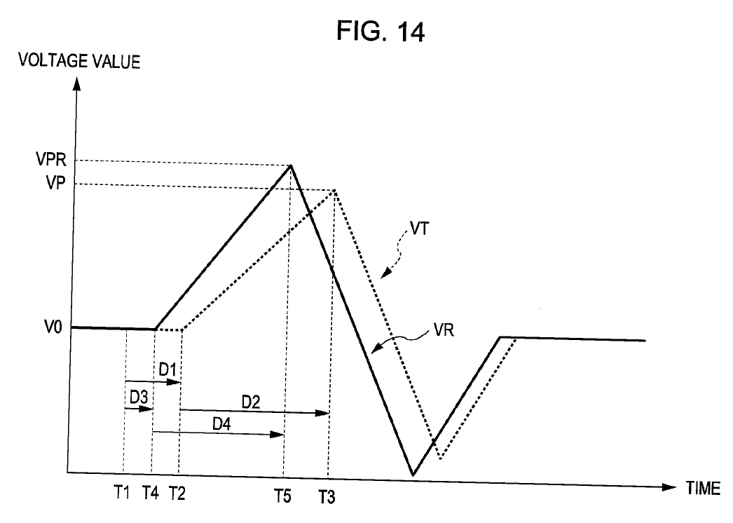

FIG. 14 is a diagram showing a relationship between the reference signal VR and the detection signal VT. As described with reference to FIG. 9, the detection signal VT includes voltage values for each of a first time T1, a second time T2 after a first period of time D1 has passed from the first time T1, and a third time T3 after a second period of time D2 has passed from the second time T2. The voltage value from the first time T1 to the second time T2 is the reference value V0. At the second time T2, the voltage value starts to change (increase). At the third time T3, the voltage value becomes a maximum value VP.

The reference signal VR includes voltage values for each of the first time T1, a fourth time T4 after a third period of time D3 has passed from the first time T1, and a fifth time T5 after a fourth period of time D4 has passed from the fourth time T4. From the first time T1 to the fourth time T4, the voltage value is the reference value V0. At the fourth time T4, the voltage value starts to change (increase), and the voltage value becomes the maximum value VPR at the fifth time T5.

In the detection signal VT, the first time T1 is a time when a driving signal is input to the piezoelectric element 25. The second time T2 is a time when ejection of ink droplets from the ejection nozzle 16 is started. The third time T3 is a time when the ink droplets from the ejection nozzle 16 reach (contact) the detection unit 45.

In the reference signal VR, the first time T1 corresponds to a time when a driving signal is input to the piezoelectric element 25. The fourth time T4 corresponds to a time when the ejection of the ink droplets from the ejection nozzle 16 is started. The fifth time T5 corresponds to a time when the ink droplets from the ejection nozzle 16 reach (contact) the detection unit 45.

When the viscosity of the ink ejected from the ejection nozzle 16 is higher than that of the ink in the initial state, the first period of time D1 of the detection signal VT is longer than the third period of time D3 of the reference signal VR. Accordingly, the processing device 47 can acquire information on the viscosity of the ink in the initial state based on a difference between the first period of time D1 that can be acquired from the detection signal VT and the third period of time D3 that can be acquired from the reference signal VR or a ratio of the first period of time D1 to the third period of time D3.

In addition, when the viscosity of the ink ejected from the ejection nozzle 16 is higher than that of the ink in the initial state, the second period of time D2 of the detection signal VT is longer than the fourth period of time D4 of the reference signal VR. Accordingly, the processing device 47 can acquire information on the viscosity of the ink in the initial state based on a difference between the second period of time D2 that can be acquired from the detection signal VT and the fourth period of time D4 that can be acquired from the reference signal VR or a ratio of the second period of time D2 to the fourth period of time D4.

In addition, when the viscosity of the ink ejected from the ejection nozzle 16 is higher than that of the ink in the initial state, the maximum value VP of the detection signal VT is smaller than the maximum value VPR of the reference signal VR. Accordingly, the processing device 47 can acquire information on the viscosity of the ink in the initial state based on a difference between the maximum value VP that can be acquired from the detection signal VT and the maximum value VPR that can be acquired from the reference signal VR or a ratio of the maximum value VP to the maximum value VPR.

As described above, the processing device 47 acquires at least one of information on the difference between the first period of time D1 and the third period of time D3 or the ratio of the first period of time D1 to the third period of time D3, information on the difference between the second period of time D2 and the fourth period of time D4 or the ratio of the second period of time D2 to the fourth period of time D4, and information on the difference between the maximum value VP of the detection signal VT and the maximum value VPR of the reference signal VR or the ratio of the maximum value VP of the detection signal VT to the maximum value VPR of the reference signal VR. Then, the processing device 47 can acquire information on the viscosity of the ink in the initial state based on the acquired result.

The operation for acquiring the information on the viscosity of the ink ejected from any one ejection nozzle 16 among the plurality of the ejection nozzles 16 has been described as above. The control device 58 performs an operation for ejecting ink from each ejection nozzle 16 among the other ejection nozzles 16. The control device 58 individually performs the detection operation for each ejection nozzle 16 by using the detection system 8 and performs the operation for acquiring the information on the viscosity of the ink ejected from each ejection nozzle 16.

The control device 58 controls the operation of the ink jet printer 1 based on the information on the viscosity of the ink ejected from each ejection nozzle 16 which has been acquired by using the detection system 8. In this embodiment, the control device 58 changes a measured value output from the measurement device 61 based on the information on the viscosity of the ink ejected from each ejection nozzle 16 which has been acquired by the detection system 8 including the processing device 47 (Step SA3).

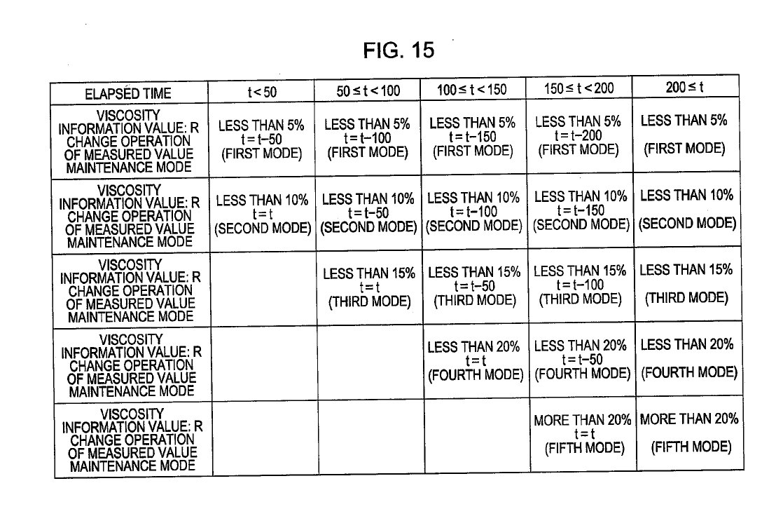

FIG. 15 is a diagram showing an example of a condition for changing the measured value output from the measurement device 61 which is set in correspondence with the information on the viscosity of ink acquired by the detection system 8. In this embodiment, a relationship between the information on the viscosity of ink and the condition for changing the measured value which is shown in FIG. 15 is stored in the memory device 60 in advance.

The viscosity information value R shown in FIG. 15, for example, includes a value relating to a ratio of the third period of time D3 to the first period of time D1 and a difference between the third period of time D3 and the first period of time D1. In particular, the viscosity information value R is (D1−D3)/D3. In FIG. 15, the viscosity information value R is expressed in percentage. As the viscosity information value R decreases, the viscosity of ink at a time of detection using the detection system 8 has changed less (the viscosity has not increased) from the initial status.

In this embodiment, the measured value output from the measurement device 61 is changed based on the viscosity information value R acquired using the detection system 8. When the viscosity information value R is small (the viscosity of the ink has not increased from the initial state), the measured value is changed such that the elapsed time t from the reference time (completion time of the maintenance process performed previously) has a decreased value. On the other hand, when the viscosity information value R is large (the viscosity of the ink has increased from the initial state), the measured value is changed such that the elapsed time t from the reference time has an increased value.

In the example shown in FIG. 15, when the viscosity information value R is less than 5%, the measured value output from the measurement device 61 is changed such that the maintenance mode of the maintenance process to be performed becomes the first mode, that is, the changed elapsed time t becomes zero hour in the timer cleaning table shown in FIG. 11. In addition, in FIG. 15, t is defined as a numeral value equal to or larger than zero.

When the viscosity information value R is equal to or larger than 5% and is smaller than 10%, the measured value output from the measurement device 61 is changed such that the maintenance mode of the maintenance process to be performed becomes the second mode, that is, the changed elapsed time t is smaller than 50 hours in the timer cleaning table shown in FIG. 11.

When the viscosity information value R is equal to or larger than 10% and is smaller than 15%, the measured value output from the measurement device 61 is changed such that the maintenance mode of the maintenance process to be performed becomes the third mode, that is, the changed elapsed time t is equal to or larger than 50 hours and is smaller than 100 hours in the timer cleaning table shown in FIG. 11.

When the viscosity information value R is equal to or larger than 15% and is smaller than 20%, the measured value output from the measurement device 61 is changed such that the maintenance mode of the maintenance process to be performed becomes the fourth mode, that is, the changed elapsed time t is equal to or larger than 100 hours and is smaller than 150 hours in the timer cleaning table shown in FIG. 11.

When the viscosity information value R is larger than 20%, the maintenance mode of the maintenance process to be performed is set to the fifth mode.

The control device 58 sets the content of the maintenance based on the changed measured value and the timer cleaning table (Step SA4). The control device 58 selects a specific maintenance mode from among five maintenance modes as shown in FIGS. 11 and 15 based on the changed measured value.

As an example, in a case where, for example, the elapsed time t is 25 hours, when the viscosity information value R acquired by the detection system 8 is 3%, the measured value t (=25 hours) is changed to a measured value t=t−50 (=0 hour). In addition, as described above, t is defined as a numeral value equal to or larger than 0, and accordingly, t becomes 0 hour. Since the measured value t=0 hour corresponds to 0 hour in the timer cleaning table shown in FIG. 11, the first mode is set as the content (the maintenance mode) of the maintenance.

On the other hand, in a case where, for example, the elapsed time t is 75 hours, when the viscosity information value R acquired by the detection system 8 is 4%, the measured value t (=75 hours) is changed to a measured value t=t−100 (=0 hour). Since the measured value t=0 hour corresponds to 0 hour in the timer cleaning table shown in FIG. 11, the first mode is set as the content (the maintenance mode) of the maintenance.

In addition, in a case where, for example, the elapsed time t is 75 hours, when the viscosity information value R acquired by the detection system 8 is 7%, the measured value t (=75 hours) is changed to a measured value t=t−50 (=25 hours). Since the measured value t=25 hours corresponds to “less than 50 hours” in the timer cleaning table shown in FIG. 11, the second mode is set as the content (the maintenance mode) of the maintenance.

On the other hand, in a case where, for example, the elapsed time t is 125 hours, when the viscosity information value R acquired by the detection system 8 is 7%, the measured value t (=125 hours) is changed to a measured value t=t−100 (=25 hours). Since the measured value t=25 hours corresponds to “less than 50 hours” in the timer cleaning table shown in FIG. 11, the second mode is set as the content (the maintenance mode) of the maintenance.

On the other hand, when the ink jet printer 1 is not operated for a long time and the elapsed time t is equal to or larger than 200 hours, the measured value t is not changed, and the maintenance mode on the basis of the viscosity information value R is performed.

The control device 58 controls the maintenance device 13 so as to perform a maintenance process for the ejection head 4 in the selected maintenance mode. The maintenance device 13 performs a maintenance operation (maintenance operation) for the record head 4 in the selected maintenance mode (Step SA5).

Then, by completing the maintenance operation, a series of processes including the detecting process using the detection system 8 and the maintenance process using the maintenance device 13 ends (Step SA6).

Thereafter, the control device 58 starts a recording operation for a recording sheet in the record area by using the record unit 2.

Here, an example in which the viscosity information value R is a value relating to the ratio of the third period of time D3 to the first period of time D1 and the difference between the third period of time D3 and the first period of time D1 has been described. However, the viscosity information value R may be a value relating to a ratio of the fourth period of time D4 to the second period of time D2 and a difference between the fourth period of time D4 and the second period of time D2, that is, (D2−D4)/D4. In addition, the viscosity information value R may be a value relating to a ratio of the extreme value VPR to the extreme value VP and a difference between the extreme values VPR and VP, that is, (VP−VPR)/VPR. In addition, as the viscosity information value R, a combination of (D1−D3)/D3, (D2−D4)/D4, and (VP−VPR)/VPR may be used.

As described above, according to this embodiment, the detection device 46 can output the detection signal on the basis of the ink ejected from the ejection nozzle 16. Accordingly, information on the viscosity of the ink actually ejected from the ejection nozzle 16 can be precisely acquired based on the detection signal in a speedy manner. In a case where a maintenance process is performed based on a measured value of the measurement device 61 that measures the elapsed time t from the reference time by the maintenance device 13, by changing the measured value based on the information of the viscosity of ink acquired by the processing device 47, an appropriate maintenance process by using the maintenance device 13 can be performed. Accordingly, it is possible to suppress unnecessary consumption of ink and maintain an excellent ejection state.

According to this embodiment, the discharge amount of ink discharged from the ejection nozzle 16 in a maintenance process can be set to an optimal value. When the viscosity of the ink has not increased, the measured value is changed, and the discharge amount of the ink discharged from the ejection nozzle 16 can be set to a small value, and accordingly, unnecessary consumption of the ink can be suppressed. On the other hand, when the viscosity of the ink has increased, the measured value is changed, and the discharge amount of the ink discharged from the ejection nozzle 16 can be set to a large value, and accordingly, an excellent ejection state can be recovered.

In this embodiment, when the flushing operation of Step SA4 is performed, an operation for discharging a predetermined amount of ink droplets only from an ejection nozzle 16 for which the viscosity of the ink has increased from the initial state can be performed, or an operation for discharging ink droplets from a plurality of or all of the ejection nozzles 16 can be performed.

In addition, in this embodiment, when it is determined that the viscosity of the ink has increased from the initial state, the size of ink droplets ejected from the ejection nozzle 16 in a maintenance operation performed by the maintenance device 13 can be set to be larger than that of ink droplets ejected from the ejection nozzle 16 in a detection operation performed by the detection system 8 for discharging the ink droplets from the ejection nozzle 16. For example, the driving signal (discharge pulse DP) may be adjusted for changing the size of the ink droplets.

In addition, in this embodiment, when the detection operation using the detection system 8 is performed, the detection operation may be performed for only one ejection nozzle 16 from among the plurality of the ejection nozzles 16, instead of performing the test operation for each of the plurality of the ejection nozzles 16. In addition, an ejection nozzle dedicated for performing the detection operation using the detection system 8 may be provided in addition to the ejection nozzle 16 that performs the recording operation for a recording sheet, and the detection operation may be performed for the dedicated ejection nozzle.

In this embodiment, since the electrode member 56 and the nozzle substrate 21 are configured to be positive and negative electrodes, the voltage value slowly increases from the second time T2 to the third time T3, and the extreme value of the detection signal VT becomes the maximum value. However, when the electrode member 56 and the nozzle substrate 21 are configured to be negative and positive electrodes, the voltage value slowly decreases from the second time T2 to the third time T3, and the extreme value of the detection signal VT becomes the minimum value. Even in such a case, the processing device 47 can acquire information on the viscosity of ink based on the detection signal.

### Second Embodiment

Next, a second embodiment will be described. In descriptions below, to a same or equivalent constituent portion as that of the above-described first embodiment, a same reference sign is attached, and a description thereof is simplified or omitted.

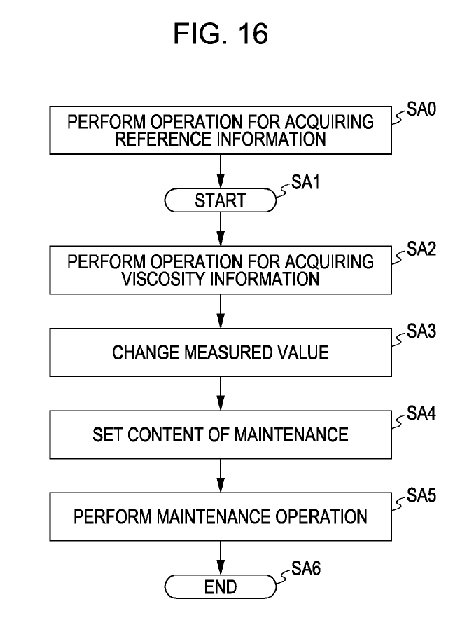

FIG. 16 is a flow chart for describing the operation of an ink jet printer 1 according to the second embodiment. A featured portion of this embodiment is that the ink jet printer 1 performs an operation (reference information acquiring operation) for acquiring a reference signal VPR on the basis of ink in the initial state, which is ejected from the ejection nozzle 16, in advance.

In this embodiment, for example, when an ink cartridge 48 is replaced with a new one, the reference information acquiring operation (Step SA0) is performed. The detection system 8 performs a detection operation by using ink of the ink cartridge 48 right after the replacement. Since the ink of the ink cartridge 48 right after the replacement can be regarded as ink in the initial state, a detection system 8 acquires information on the reference signal VR using the ink. The acquired information on the reference signal VR is stored in a memory device 60.

After the reference information acquiring operation is performed, a control device 58 directs to start a detection operation by using the detection system 8 (Step SA1) performs a viscosity information acquiring operation (Step SA2), changes a measured value (Step SA3), sets the content of maintenance (Step SA4), and performs a maintenance operation (Step SA5) at predetermined timings, similar to those in the first embodiment.

In addition, in the above-described first and second embodiments, examples in which the ink jet-type recording apparatus is the ink jet printer 1 have been described. However, the ink jet-type recording apparatus is not limited to the ink jet printer, and may be a recording apparatus such as a copier or a facsimile machine.

In addition, in the above-described embodiments, an example in which the fluid ejecting apparatus is a liquid ejecting apparatus (liquid-form material ejecting apparatus) that ejects liquid (liquid-form material) such as ink has been described. However, the fluid ejecting apparatus according to the present invention may be applied to a fluid ejecting apparatus that ejects or discharges fluid other than ink. The fluid that can be ejected by the fluid ejecting apparatus includes a liquid-form material as liquid in which particles of functional materials are dispersed or dissolved and a fluid-form material in the shape of gel.

In addition, in the above-described embodiments, as the liquid (a liquid-form material or a particle-form material) ejected from the fluid ejecting apparatus, not only ink but also liquid responding to a special use may be used. A specific device can be produced by providing an ejection head that can eject liquid responding to the special use in the fluid ejecting apparatus, ejecting the liquid responding to the special use from the ejection head, and attaching the liquid to a predetermined object. For example, the liquid ejecting apparatus (liquid-form material ejecting apparatus) according to the present invention may be applied to a liquid ejecting apparatus that ejects liquid (liquid-form material) in which a material such as an electrode material or a color material that is used for manufacturing a liquid crystal display, an EL (electroluminescence) display, a field emission display (FED), or the like is dispersed (dissolved) into a specific dispersion medium (solvent).

In addition, the liquid ejecting apparatus may be a liquid ejecting apparatus that ejects a biological organic material used for producing a bio chip or a liquid ejecting apparatus that is used as a precision pipette and ejects liquid as a sample material.

In addition, the liquid ejecting apparatus may be a liquid ejecting apparatus that ejects lubricant to a precision machine such as a watch or a camera in a pin-point manner, a liquid ejecting apparatus that ejects transparent resin liquid such as a ultraviolet curable resin on a substrate for forming a minute half-sphere lens (optical lens) that is used in an optical communication element or the like, a liquid ejecting apparatus that ejects etching liquid that is acid or alkali for etching a substrate or the like, a fluid-form material ejecting apparatus that ejects gel, or a toner jet-type recording apparatus that ejects solid such as a particle body including toner. The present invention may be applied to any one type of the above-described fluid ejecting apparatuses.

What is claimed is:

1. A fluid ejecting apparatus comprising:
an ejection head having an ejection face formed with an ejection nozzle that ejects fluid;
a detection device having a detector that is arranged to face the ejection face with a predetermined gap provided therebetween and to which the fluid ejected from the ejection nozzle is supplied, the detection device outputting a detection signal in response to the fluid ejected from the ejection nozzle;
a processing unit that obtains information on the viscosity of the fluid on the basis of the detection signal;
a measurement device that measures an elapsed time from a reference time and outputting the measured value;
a maintenance device capable of performing maintenance of the ejection head; and
a control device that controls the maintenance device on the basis of the measured value output from the measurement device,
wherein the measurement device changes the measured value to be output on the basis of the information obtained by the processing unit.

2. The fluid ejecting apparatus according to claim 1, wherein the reference time includes a completion time of a maintenance process performed earlier.

3. The fluid ejecting apparatus according to claim 1, wherein the control device controls the maintenance device on the basis of the changed measured value.

4. The fluid ejecting apparatus according to claim 1, wherein the content of the maintenance process performed by the maintenance device is set in such a manner as to correspond to the elapsed time from the reference time, and
wherein the control device sets the content of the maintenance process on the basis of the measured value, and controls the maintenance device on the basis of the set content.

5. The fluid ejecting apparatus according to claim 4, wherein the maintenance device is able to perform a maintenance process including an operation for discharging the fluid from the ejection nozzle in cooperation with the ejection head in order to maintain the ejection characteristics of the ejection head, and is able to perform the maintenance process in a plurality of modes in which the amounts of discharge of the fluid from the ejection nozzle differ from one another, and
wherein, on the basis of the measured value, the control device selects a specific mode from the plurality of modes and controls the maintenance device so as to perform the maintenance process in the selected mode.

6. The fluid ejecting apparatus according to claim 5, wherein the maintenance process includes a process for performing a flushing operation for ejecting the fluid from the ejection nozzle in advance before the fluid from the ejection nozzle is supplied to a predetermined object.

7. The fluid ejecting apparatus according to claim 1, wherein the maintenance device comprises a capping device having a cap member capable of forming a space with the ejection face, and a suction device capable of sucking fluid in the space.

8. The fluid ejecting apparatus according to claim 1, wherein the maintenance device comprises the detector.

9. The fluid ejecting apparatus according to claim 1, wherein the detection device supplies an electric field between the ejection face and the detector and outputs a change in a voltage value with respect to time based on electrostatic induction when the fluid is moved from the ejection nozzle to the detector.

10. The fluid ejecting apparatus according to claim 9, wherein the detection signal contains the voltage value for each of a first time, a second time after a first period of time has passed from the first time, and a third time after a second period of time has passed from the second time, the voltage value is a reference value from the first time to the second time, the voltage value starts to change at the second time, and the voltage value reaches an extreme value at the third time, and
wherein the processing unit determines at least one of the first period of time, the second period of time, and the difference between the reference value and the extreme value, and obtains information on the viscosity of the fluid on the basis of the determined result.

11. The fluid ejecting apparatus according to claim 10, further comprising a driving element that varies the pressure in the space connected to the ejection nozzle on the basis of a driving signal to be input in order to eject the fluid from the ejection nozzle,
wherein the first time includes a time at which the driving signal is input to the driving element.

12. The fluid ejecting apparatus according to claim 10, wherein the second time includes a time at which the ejection of the fluid is started from the ejection nozzle, and
the third time includes a time at which the fluid from the ejection nozzle reaches the detector.

13. The fluid ejecting apparatus according to claim 9, further comprising a storage device storing a reference signal that is output from the detection device on the basis of fluid in an initial state,
wherein the processing unit obtains information on the amount of change in the viscosity of the fluid in the initial state on the basis of the detection signal and the reference signal.

14. The fluid ejecting apparatus according to claim 13, wherein the detection signal contains the voltage value for each of a first time, a second time after a first period of time has passed from the first time, and a third time after a second period of time has passed from the second time, the voltage value is a reference value from the first time to the second time, the voltage value starts to change at the second time, and the voltage value reaches an extreme value at the third time,
wherein the reference signal contains the voltage value for each of a first time, a fourth time after a third period of time has passed from the first time, and a fifth time after a fourth period of time has passed from the fourth time, the voltage value is a reference value from the first time to the fourth time, the voltage value starts to change at the fourth time, and the voltage value reaches an extreme value at the fifth time, and
wherein the processing unit determines at least one of information on the difference between the first period of time and the third period of time, information on the difference between the second period of time and the fourth period of time, and the difference between the extreme value of the detection signal and the extreme value of the reference signal, and obtains information on the viscosity of the fluid on the basis of the determined result.

15. The fluid ejecting apparatus according to claim 14, further comprising a driving element that varies the pressure in the space connected to the ejection nozzle on the basis of a driving signal to be input in order to eject the fluid from the ejection nozzle,
wherein the first time includes a time at which a driving signal is input to the driving element.

16. The fluid ejecting apparatus according to claim 14, wherein the second time and the fourth time include a time at which the ejection of the fluid is started from the ejection nozzle, and
the third time and the fifth time include a time at which the fluid from the ejection nozzle reaches the detector.

17. The fluid ejecting apparatus according to claim 1, wherein the fluid is liquid.

18. A method of controlling a fluid ejecting apparatus including an ejection head having an ejection face formed with an ejection nozzle that ejects fluid, the method comprising:
arranging a detector so as to face the ejection face with a predetermined gap provided therebetween, supplying the fluid ejected from the ejection nozzle to the detector, and obtaining a detection signal in response to the fluid ejected from the ejection nozzle by using the detector;
obtaining information on the viscosity of the fluid on the basis of the detection signal;
measuring an elapsed time from a reference time and outputting the measured value; and
performing maintenance of the ejection head on the basis of the output measured value,
wherein the output measured value is changed on the basis of the information on the viscosity.
